(19) United States
(12) Patent Application Publication
(10) Pub. No.: US 2013/0060617 A1
(43) Pub. Date: Mar. 7, 2013

(54) Rewarding Fiscal Responsibility

(71) Applicants: Erik Stephen Ross, Charlotte, NC (US); Leonard Marc Nathan, Wilmington, DC (US); Dianne Agnes Fair, Hockessin, DE (US); Alexander Azariy Shenkar, Rosell, GA (US); Darren Paul Stillwell, Fort Mill, SC (US); Ellen Howse Brannen, Bear, DE (US); Mei-Ling In Johnson, Wilmington, DE (US); Susan S. Thomas, Gastonia, NC (US); Yolandis Rogers, Charlotte, NC (US); Eric James Golla, Phoenix, AZ (US)

(72) Inventors: Erik Stephen Ross, Charlotte, NC (US); Leonard Marc Nathan, Wilmington, DC (US); Dianne Agnes Fair, Hockessin, DE (US); Alexander Azariy Shenkar, Rosell, GA (US); Darren Paul Stillwell, Fort Mill, SC (US); Ellen Howse Brannen, Bear, DE (US); Mei-Ling In Johnson, Wilmington, DE (US); Susan S. Thomas, Gastonia, NC (US); Yolandis Rogers, Charlotte, NC (US); Eric James Golla, Phoenix, AZ (US)

(73) Assignee: BANK OF AMERICA CORPORATION, Charlotte, NC (US)

(21) Appl. No.: 13/224,048

(22) Filed: Sep. 1, 2011

(51) Int. Cl. G06Q 30/00; G06Q 40/00

(52) U.S. Cl. 705/14.17; 705/35; 705/14.21

(57) ABSTRACT

An enhanced rewards server may analyze the progress of an individual, group, and/or organization towards a financial goal and may reward the individual, group, and/or organization once the goal has been achieved. The enhanced rewards server may analyze various pieces of information, including transaction data related to credit cards and bank accounts, to determine whether the individual, group, and/or organization is making progress towards the financial goal. In addition, the rewards server may consider progress evaluations made by a social network associated with the individual, group, and/or organization in deciding whether or not a reward should be transmitted.

### TECHNICAL FIELD

Aspects of the invention generally relate to ways in which an entity may reward fiscal responsibility. In particular, an enhanced rewards server may be used to determine the types of rewards that are appropriate under predefined conditions.

### BACKGROUND

Organizations, groups, and/or individuals often struggle with fiscal responsibility. In spite of their best efforts, these entities may succumb to the temptation of spending beyond their means.

For instance, an organization such as a school may create an annual operating budget based on public funds appropriated to the school. However, due to a need for more supplies and/or personnel during a given year, the school may overshoot its budget significantly. In these scenarios, the school may need to seek extra funds from the local government, a situation that that may create problems for both the local government and the school.

Alternatively, an individual may have a monthly budget based on a personal income level. During any given month, the individual may splurge on items related to entertainment, electronics, and clothing, among other things, thus causing the individual to exceed his or her budget. In these scenarios, the individual may face undesirable consequences, including having to take out high interest loans, asking family for financial help, and/or going into bankruptcy.

Thus, there is a need to keep individuals, groups, and/or organizations from financially reckless behavior.

### BRIEF SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Aspects of the disclosure address one or more of the issues mentioned above by disclosing methods, non-transitory computer readable media, and apparatuses for rewarding financially sound or responsible behavior. An entity may reward an individual, group, and/or organization with cash back, redeemable points, discounts, interest rate incentives, etc. when the entity determines that the individual, group, and/or organization exhibits fiscally responsible behavior.

Other aspects of the disclosure relate to an enhanced rewards server that may analyze financial data related to an individual, group, and/or organization in order to determine progress of that individual, group, and/or organization towards a financial goal. The server may also determine a social network associated with the individual, group, and/or organization. Once determined, the social network may also evaluate the performance of the individual, group, and/or organization in achieving the financial goal.

Aspects of the disclosure may be provided in a computer-readable medium having computer-executable instructions to perform one or more of the process steps described herein.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The present invention is illustrated by way of example and is not limited in the accompanying figures in which like reference numerals indicate similar elements and in which:

FIG. 1 shows an illustrative operating environment in which various aspects of the disclosure may be implemented.

FIG. 2 is an illustrative block diagram of workstations and servers that may be used to implement the processes and functions of one or more aspects of the present disclosure.

FIG. 3 is a flow diagram of steps performed by an enhanced rewards server in accordance with one or more aspects of the disclosure.

### DETAILED DESCRIPTION

As discussed above, individuals, groups, and/or organizations still struggle with maintaining fiscally sound behavior. Therefore, the example embodiments provide novel methodologies to incentivize financially responsible behavior.

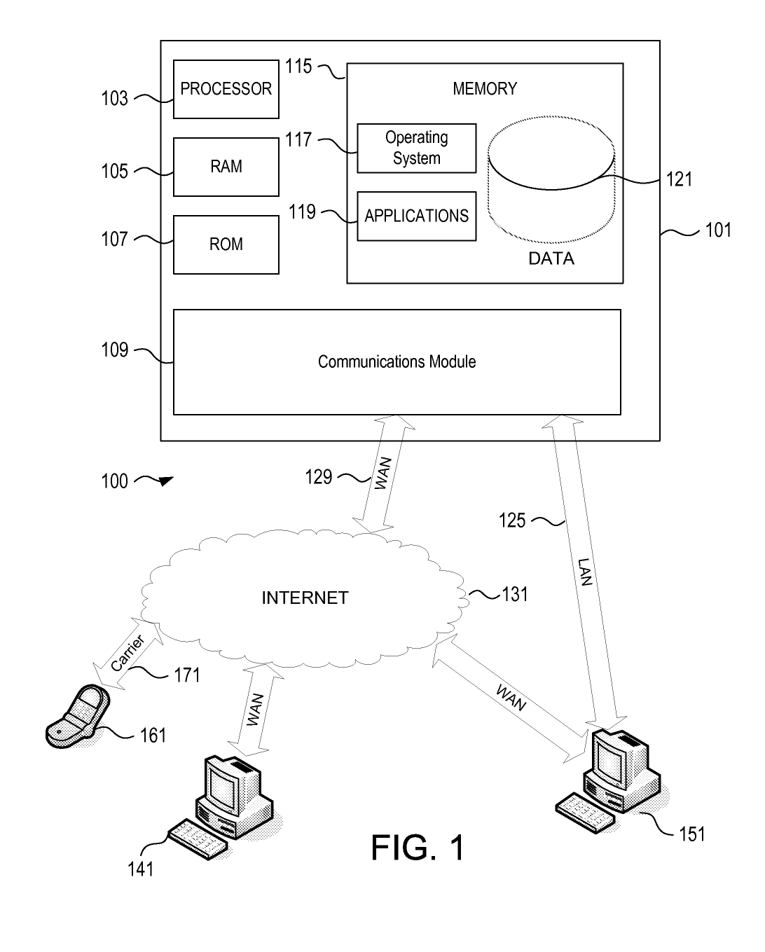

FIG. 1 illustrates an example of a suitable computing system environment 100 that may be used according to one or more illustrative embodiments. The computing system environment 100 is only one example of a suitable computing environment and is not intended to suggest any limitation as to the scope of use or functionality contained in the disclosure. The computing system environment 100 should not be interpreted as having any dependency or requirement relating to any one or combination of components shown in the illustrative computing system environment 100.

The disclosure is operational with numerous other general purpose or special purpose computing system environments or configurations. Examples of well known computing systems, environments, and/or configurations that may be suitable for use with the disclosed embodiments include, but are not limited to, personal computers (PCs), server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including random-access memory (RAM) 105, read-only memory (ROM) 107, communications module 109, and memory 115. Processor 103 and its associated components may allow the computing device 101 to run a series of computer-readable instructions related to analyzing financial transaction data and/or data related to financial goals to determine if a reward is appropriate. Processor 103 may also direct computing device 101 to transmit a predetermined reward to an individual, group, and/or organization based on this analysis.

Computing device 101 typically includes a variety of computer readable media. Computer readable media may be any available media that may be accessed by computing device 101 and include both volatile and nonvolatile media, removable and non-removable media. By way of example, and not limitation, computer-readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal includes a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown). Exemplary usages include scanning and converting paper documents, e.g., correspondence, receipts, etc. to digital files.

Although not shown, RAM 105 may include one or more are applications representing the application data stored in RAM 105 while the computing device 101 is on and corresponding software applications (e.g., software tasks) are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Also, some or all of the computer executable instructions for computing device 101 may be embodied in hardware or firmware.

Computing device 101 may operate in a networked environment supporting connections to one or more remote computing devices, such as computing devices 141, 151, and 161. The computing devices 141, 151, and 161 may be personal computing devices or servers that include many or all of the elements described above relative to the computing device 101. Computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, computing device 101 may be connected to the LAN 125 through a network interface or adapter in the communications module 109. When used in a WAN networking environment, the computing device 101 may include a modem in the communications module 109 or other means for establishing communications over the WAN 129, such as the Internet 131 or other type of computer network. It will be appreciated that the network connections shown are illustrative and other means of establishing a communications link between the computing devices may be used. Various well-known protocols such as TCP/IP, Ethernet, FTP, HTTP and the like may be used, and the system can be operated in a client-server configuration to permit a user to retrieve web pages from a web-based server. Any of various conventional web browsers can be used to display and manipulate data on web pages.

Additionally, one or more application programs 119 used by the computing device 101, according to an illustrative embodiment, may include computer executable instructions for invoking user functionality related to communication including, for example, email, short message service (SMS), and voice input and speech recognition applications (e.g., for transmitting reward information and/or receiving goal information, etc.). In addition, the application programs 119 may include computer executable instructions for invoking user functionality related to determining a reward for fiscally sound behavior.

Embodiments of the disclosure may include forms of computer-readable media. Computer-readable media include any available media that can be accessed by computing device 101. Computer-readable media may comprise storage media and communication media and in some examples may be non-transitory. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor 103 on computing device 101. Such a processor may execute computer-executable instructions stored on a computer-readable medium.

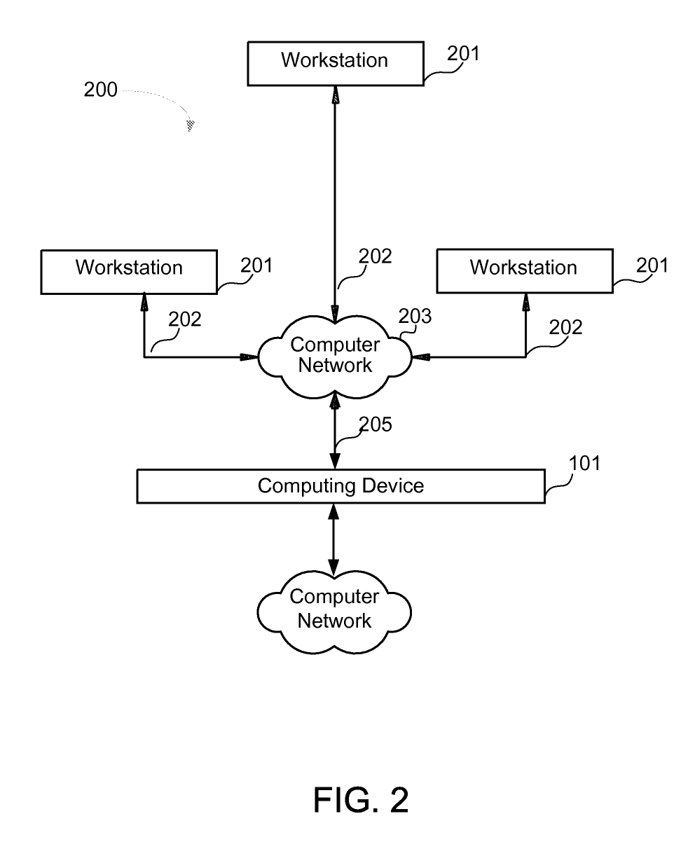

Referring to FIG. 2, an illustrative system 200 for implementing example embodiments according to the present disclosure is shown. As illustrated, system 200 may include one or more workstation computers 201. Workstations 201 may be local or remote, and may be connected by one of communications links 202 to computer network 203 that is linked via communications links 205 to computing device 101. Workstations 201 may include many of the same hardware/software components as computing device 101. In some embodiments, workstations 201 may represent data stores for storing transaction data accessed and used by computing device 101. In other embodiments, workstations 201 may represent various user terminals for accessing computing device 101. In system 200, computing device 101 may be any suitable server, processor, computer, or data processing device, or combination of the same. Computing device 101 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and computing device 101, such as network links, dial-up links, wireless links, hard-wired links, etc.

The steps that follow in the Figures may be implemented by one or more of the components in FIGS. 1 and 2 and/or other components, including other computing devices.

In accordance with various aspects of the disclosure, methods, computer-readable media, and apparatuses are disclosed that allow an entity, such as a company, financial organization, bank, credit union, government agency, university, individual, group, etc., to implement advanced methodologies for rewarding fiscally sound behavior. In general, the rewards may include a cash reward, discounts (e.g., at third party vendors), interest rate incentives (e.g., discounts on an interest rate associated with a home, auto, etc. loan and/or an increase in an interest rate associated with a bank account maintained by an entity administering the rewards program, etc.).

As mentioned before, to implement the rewards solution, an entity (e.g., a financial organization) may use the computing device 101 (hereinafter, enhanced rewards server 101) configured to run computer-executable program instructions related to each step of the rewards process. If the entity implementing the enhanced rewards server 101 is a financial organization (e.g., a bank), the bank may already possess credit card data, checking/savings account data, and/or other types of financial and/or transaction data about each of its customers. The bank may then use the enhanced rewards server 101 to analyze this data to determine whether or not a given customer is spending responsibly. In analyzing the data, the bank may apply predefined business logic rules (e.g., in the form of a computer algorithm stored on a computer-readable medium) to determine what, if any, reward may be justified.

In certain aspects, the entity managing the enhanced rewards server 101 may also receive information about financial goals (e.g., shopping lists, wish lists, savings goals, investment goals, etc.) for various individuals, groups, and/or organizations. These goals may relate to specific benchmarks that the individual, group, and/or organization have set for themselves to achieve fiscal responsibility. If an individual, group, and/or organization achieves a financial goal or a specific milepost towards the goal, enhanced rewards server 101 may determine that a predetermined reward may be appropriate. In certain aspects, the financial goal may be a spending limit and/or a savings goal over a predetermined time period.

For instance, one particular goal for an individual may be to spend less money at restaurants to allow the individual to save money for a car. If the entity managing enhanced rewards server 101 is a bank, the enhanced rewards server 101 may be a part of a network (e.g., network 203) in communication with various servers (e.g., workstations 201) storing monthly transaction data related to the individual. The enhanced rewards server 101 in the bank may then analyze the monthly transaction data for the individual and may determine the spending patterns of the individual at restaurants over a predetermined time period. If the data suggests that the individual is spending less money over the time period or if the individual is spending less than a predetermined threshold, the server 101 may determine a predetermined reward (e.g., a cash reward, etc.) to transmit to the individual (e.g., via communications module 109). Also, if the enhanced rewards server 101 determines that the spending trends at restaurants are not below a predetermined threshold or suggest an increase in spending over the predetermined time period, enhanced rewards server 101 may determine that no reward is appropriate for this individual. The enhanced rewards server 101 may also assess a penalty. Penalties may include, for example, lowering a credit limit permanently or for a predetermined amount of time, transferring a predetermined amount of money to a savings account that cannot be withdrawn without paying a penalty fee, etc. In some aspects, penalties may also include a requirement to give money to charity or to give a donation to a political affiliation that is different from the political affiliation of the individual. To ensure that the individual follows through on the penalty, a predetermined amount of cash may be soft reserved under the supervision of an executor or administrator (e.g., another member of the social network, a family member, etc.). In this way, enhanced rewards server 101 may incentivize the individual for financially responsible behavior.

In some aspects, server 101 may establish a tiered rewards scheme for reaching a specific milepost along the path to a final goal. Using the example of an individual wishing to reduce spending at restaurants from above, enhanced rewards server 101 may reward the individual an amount that is proportional to the level of spending reduction over a time interval (e.g., by establishing a reward threshold). For example, the enhanced rewards server 101 may compare an individual's spending at restaurants from one month to the next, and may identify a month-to-month spending decline of 5%. For this percentage decrease, the enhanced rewards server 101 may credit a predetermined first amount of cash back (e.g. $50) to the individual's account. For a month-to-month spending decline of 10%, the enhanced rewards server 101 may credit a predetermined second amount of cash back that is larger than the first amount (e.g., $100 dollars cash back), and so on and so forth. In this way, the individual may receive a reward that is proportional to the level of spending reduction shown by the individual. In other embodiments, the enhanced rewards server 101 may automatically increase the reward by a predetermined amount or percentage if the month-over-month spending at restaurants continues to decline.

In some embodiments, the information detailing a goal may be generated by enhanced rewards server 101 rather than by the individual, group, and/or organization to which the goal applies. For instance, enhanced rewards server 101 may examine the transaction data associated with a private company to determine that the company would benefit from a reduction in spending on equipment upgrades. Thus, the enhanced rewards server 101 may set up a goal with specific intermediate mileposts to help the company evaluate whether or not it is achieving this goal.

In yet other aspects, enhanced rewards server 101 may facilitate a social network environment for the analysis of data and/or evaluation of performance with regards to a financial goal for an individual, group, and/or organization. For example, enhanced rewards server 101 may first establish or otherwise determine a social network related to an individual that has been assigned a financial goal. The members of the individual's social network may be based on any number of attributes that the individual may share with the members. For instance, if enhanced rewards module 101 is calculating a reward for an individual for reducing spending related to sports gear, the individual's social network may include other individuals that also have an interest in sports and sports equipment. Also, enhanced rewards server 101 may port the social network of a given individual from social networking platforms such as Facebook™, Twitter™, etc. In yet other embodiments, the social network of an individual may be established by feedback from the individual.

Once established, the social network of the individual may be used to evaluate progress of the individual towards a financial goal. For instance, enhanced rewards server 101 may give each member of an individual's social network access to some or all of the financial data used by enhanced rewards server 101 to assess whether or not an individual is making progress towards a financial goal. Enhanced rewards server 101 may also provide access to the details of the goal and the mileposts achieved by the individual to date. Enhanced rewards server 101 may electronically provide access to this information, such as, for example, via a webserver, an online banking interface, text message, and/or some other type of message. Each member of the social network may be permitted to send messages (e.g., text, audio, video, and/or a combination thereof) to the individual for encouragement. Each of the members may rate the performance of the individual and these ratings may be taken into account by enhanced rewards server 101 in both evaluating the progress of the individual towards a goal and in determining what, if any, reward should be transmitted to the individual. For example, a percentage of a reward and/or penalty may be determined based on feedback (or lack of feedback) from the members of the social network.

In one example, 30% of the reward given to an individual may be determined by feedback (or lack of feedback) from the members of the social network. Members may rate an individual's performance on a scale of 1 to 10, and an average score may be used to determine the reward. In a scenario where the total reward may be $100, $30 (i.e., 30% of $100) may be controlled by the members. If an individual receives an average score of 5 out of 10 from the members of the social network, the total reward that the individual receives may be 0.5*$30=$15+$70=$85. Here, the $15 component may represent the part of the reward determined by the members of the social network and the $70 component may be the part of the reward determined by the server 101.

The social network associated with an individual, group, and/or organization may also add peer pressure to help the individual, group, and/or organization achieve the goal because members of the social network may be directly involved in evaluating performance in achieving the goal.

In other embodiments, enhanced rewards server 101 may group together individuals, groups, and/or organizations with the same or similar goal into a single social network. In this case, enhanced rewards server 101 may generate a group performance rating for achieving the financial goal by taking into account the performance of each member of the social network. Thus, in this implementation, poor performance by any member of the social network may result in a lower performance rating for all members of the social network, thereby reducing any potential reward and/or eliminating the reward completely for the entire group. In this way, each member of the group may feel the peer pressure of other members, given the negative consequences of poor performance for all members of the group.

For example, server 101 may assign a rating number to the performance over a predetermined time period of each member of the social network with respect to a given financial goal. The rating numbers of each member of the social network may then be summed to determine which one of multiple reward categories may apply to the group (e.g., no reward category, small reward category, medium reward category, and/or big reward category). As an example, if the goal of each member of the social network is to reduce monthly spending in certain areas, server 101 may transmit no reward to each member for a month-over-month spending reduction of 0-3% in relevant areas (e.g., no reward category), a reward of $20 for a month-over-month spending reduction of 3.01-5% in relevant areas (e.g., small reward category), a reward of $40 for a month-over-month month spending reduction of 5.01-10% in relevant areas (e.g. medium reward category), and a reward of $60 for a month-over-month spending reduction of greater than 10% (e.g., big reward category). Additionally, each member may receive a bonus reward (e.g., an additional $20, etc.) when each member of the social network performs at a predetermined level (e.g., each member reduces spending by 5% or more during a given month).

In some aspects, the enhanced rewards server 101 may implement the rewards program via an interactive video game. In this embodiment, enhanced rewards server 101 may request that individuals, groups, and/or organizations answer questions related to real-life and/or hypothetical financial scenarios. The answers to these questions may allow server 101 to determine what, if any, reward should be transmitted to the appropriate entity. In some aspects, the interactive video game may be accessed from an entity's social networking account (e.g., Facebook, Twitter, etc.).

For example, one interactive video game may require an individual to answer questions about spending associated with a credit card. The game may place the individual into a scenario where he is given a credit with a predetermined credit limit (e.g., $20,000) and a monthly budget. The game may require the individual to appropriate funds based on the monthly budget for any expenses incurred during the month. If the individual maintains a low credit card balance (e.g., less than a predetermined threshold) within the game for a given month, server 101 may transmit a reward to the individual. Alternatively, if the individual acquires a high credit card balance (e.g., greater than a predetermined threshold) within the game for a given month, server 101 may transmit either a reduced reward or no reward to the individual.

In some aspects, server 101 may implement controls for guarding against individuals, groups, and/or organizations that may attempt to defraud the system/method. For instance, in a scenario where the server 101 may be monitoring credit card balances associated with a savings goal, the server may also monitor checking/savings account balances in case the individual switches to paying only cash instead of using a credit card. In addition, server 101 may implement security protocols for access to all sensitive information, including passwords, usernames, data encryption, etc.

In some aspects, information about a financial goal may be made available on a website for an individual and/or his/her social network to access. In other aspects, an individual, group, and/or organization may be required to take “defensive borrowing” education, where the individual, group, and/or organization learns how to spend appropriately and save money. This educational program may also require that the individual, group, and/or organization spend a predetermined amount of time in the “defensive borrowing” class and may require that the individual, group, and/or organization pass an exit exam. In addition, every time a borrower goes delinquent on a debt, a predetermined amount of remedial education/counselling may be required. In some embodiments, a predetermined financial incentive (e.g., bonus rewards) may be provided to those that complete the educational program and/or training certification. This educational program may be administered by an independent contractor.

In other aspects, server 101 may display an entity's risk score in a variety of ways (e.g., through the entity's online bank account portal, through regular mailings, etc.). Server 101 may also display information on ways that the entity may increase its credit quality.

In yet other aspects, server 101 may transfer a percentage of an entity's spend (e.g., over a predetermined period of time such as a year, etc.) into a separate bank account (e.g., a certificate of deposit (CD), demand deposit account (DDA), etc.) of the entity's choice to serve as a “rainy day” fund (e.g., a fund that may be used in the event of unforeseen circumstances, etc.). Server 101 may also offer the entity information on how the funds in the separate bank account may be used. In addition, server 101 may provide incentives such as payment credits and/or coupons for entities who contribute more than a minimum amount to this “rainy day” fund (e.g., as a financial goal, etc.). As an extension, other entities (e.g., family members, members of a social network, etc.) may also contribute to the “rainy day” fund.

Further, server 101 (e.g., of a bank) may offer secure credit card services and may also offer a discount annual percentage rate (APR) on credit cards for entities who agree to automatic payment via a direct debit for the minimum amount due on a credit card.

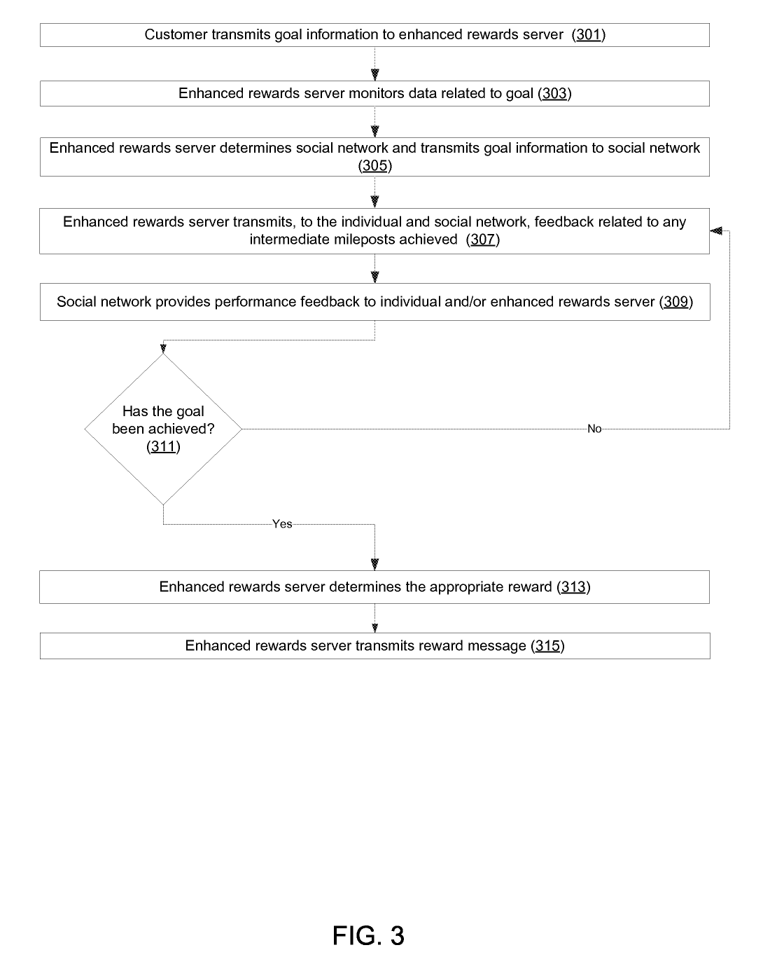

FIG. 3 shows an example flow diagram of the rewards process implemented by enhanced rewards server 101, in accordance with at least one aspect of the disclosure. The steps may be rearranged, one or more steps may be added, one or more steps may be omitted, and one or more steps may be repeated. The process shown in FIG. 3 uses debt reduction (e.g., payment of credit card balances within a predetermined time period) as an example goal assigned to an individual. In this example, the individual may submit a request to server 101 that the goal is assigned to him. The process may start out at step 301 where a customer of a financial institution may transmit goal information (e.g., desire to pay off his credit card balance within a predetermined period of time (e.g., two months)) to the enhanced rewards server 101. The enhanced rewards server 101 may then monitor data related to the goal in step 303. For instance, the rewards server 101 may periodically monitor transaction data related to the individual's credit card account provided by the financial institution. In addition, server 101 may monitor debt levels associated with other credit cards and/or other accounts (e.g., demand deposit accounts, savings, etc.) to make sure that debt levels may not be merely shifting from one account to another.

The process may then move to step 305 where server 101 may determine a social network for the individual for peer evaluation of goal performance. As mentioned earlier, the server 101 may determine the social network by evaluating characteristics of other individuals within databases that server 101 may access, from social networking websites associated with the individual, and/or from direct feedback received from the individual. Server 101 may also transmit information related to the goal to each member of the social network.

Then, in step 307, server 101 may periodically transmit information about any intermediate mileposts that may have been achieved by the individual through the process of paying off a balance associated with the credit card in question. These messages may be transmitted to both the individual and the individual's social network. For instance, server 101 may transmit a message to the individual and/or to the individual's social network (e.g., via email, SMS, via an interface associated with online banking, etc.) when the individual has paid off half of his credit card balance. In reply, in step 309, one or more members of the social network associated with the individual may transmit feedback to the individual and/or to enhanced rewards server 101 regarding performance of the individual in paying off his credit card balance.

The process may then move to step 311 where the enhanced rewards server 101 may determine whether a goal has been achieved. If the goal has not been achieved, server 101 may continue to transmit updates to the individual periodically as progress is made toward a goal (e.g., the process moves back to step 307). If no progress is made, server 101 may transmit a message to the individual detailing this information. In some embodiments, if no progress is made after a predetermined time period, server 101 may terminate future messages to the individual regarding the goal.

If the individual has achieved the specified goal (e.g., paid off his credit card balance), server 101 may determine the appropriate reward for the individual in step 313. The size of the reward may be based on a variety of factors, including the length of time taken by the individual in achieving the goal and/or the amount of the initial credit card balance paid off, among other things. For example, if the individual takes only two months to pay off the credit card balance, server 101 may transmit a $100 reward to the individual. If the same individual takes four months to pay off the credit card balance, server 101 may transmit a $200 reward to the individual.

Finally, in step 315, the enhanced rewards server 315 may transmit information regarding the nature of the reward (cash, discount, interest rate incentive, etc.). This congratulatory message may be transmitted both to the individual and to his social network.

Aspects of the invention have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the invention.

What is claimed is:

1. A non-transitory computer-readable storage medium having computer-executable program instructions stored thereon that when executed by a processor, cause the processor to perform steps comprising:
(i) receiving information related to a financial goal from an entity;
(ii) analyzing the information and financial data associated with the entity;
(iii) determining a social network associated with the entity;
(iv) transmitting the information related to the financial goal to at least one member of the social network;
(v) based on the analysis, transmitting feedback to the entity when the entity achieves an intermediate milepost of the financial goal;
(vi) receiving at least one evaluation from at least one member of the social network;
(vii) based on the analysis and the at least one evaluation, determining when the financial goal has been achieved;
(viii) when the financial goal has been achieved, determining a first reward for the entity; and
(ix) causing providing of the first reward to the entity.

2. The computer-readable storage medium of claim 1, wherein the processor further performs:
transmitting feedback to each member of the social network when the entity achieves an intermediate milepost of the financial goal.

3. The computer-readable storage medium of claim 1, wherein the first reward is chosen from the group consisting of: a cash reward, an interest rate incentive, and a discount at a third party vendor.

4. The computer-readable storage medium of claim 1, wherein the processor further performs: based on the analysis, transmitting additional feedback to the entity and each member of the social network when the entity is performing below a predetermined threshold with respect to reaching the financial goal.

5. The computer-readable storage medium of claim 1, wherein the financial goal is chosen from the group consisting of: paying off debt associated with a credit card, a savings goal, and a spending reduction in a given category.

6. The computer-readable storage medium of claim 1, wherein the financial data comprises credit card transaction data related to the entity.

7. The computer-readable storage medium of claim 1, wherein the processor further performs: determining a second reward to the entity when the entity achieves the intermediate milepost of the financial goal.

8. The computer-readable storage medium of claim 1, wherein the determining the social network of the entity is based on a shared attribute with the entity.

9. The computer-readable storage medium of claim 1, wherein the processor further performs: granting each member of the social network access to the financial data to allow the at least one member of the social network to use the financial data to generate the at least one evaluation.

10. The computer-readable storage medium of claim 1, wherein each member of the social network has the same financial goal as the entity.

11. The computer-readable storage medium of claim 1, wherein the processor further performs: implementing controls to counteract scenarios where either the entity or one of the members of the social network attempt fraud.

12. A computer-assisted method comprising:
using a processor associated with the computer, determining a social network associated with an individual, wherein the individual and each member of the social network have a same financial goal;
using the processor, analyzing transaction data associated with the individual and with each member of the social network;
using the processor and based on the analysis, determining when at least one member of the social network or the individual has achieved an intermediate milepost of the financial goal or has achieved the financial goal itself;
using the processor, when the at least one member of the social network or the individual has achieved the intermediate milepost or the financial goal itself, determining a reward for each member of the social network and the individual; and
using a communication module associated with the computer, causing providing of the reward to each member of the social network and the individual.

13. The computer-assisted method of claim 12, further comprising: using the processor, determining when at least one member of the social network or the individual has performed below a predetermined threshold with regard to the financial goal.

14. The computer-assisted method of claim 13, further comprising: using the communication module, reducing the transmitted reward when at least one member of the social network or the individual has performed below a predetermined threshold with regard to the financial goal.

15. The computer-assisted method of claim 12, wherein the transaction data comprises credit card, checking account, and savings account transaction data.

16. An apparatus comprising:
a processor; and
a memory storing computer-readable instructions that, when executed by the processor, cause the apparatus at least to perform:
receiving information related to a financial goal from an entity;
analyzing the information and financial data related to the entity;
determining a social network associated with the entity;
transmitting the information related to the financial goal to at least one member of the social network;
based on the analysis, transmitting feedback to the entity and each member of the social network when the entity achieves an intermediate milepost of the financial goal;
receiving at least one evaluation from at least one member of the social network;
based on the analysis and the at least one evaluation, determining when the financial goal has been achieved;
when the financial goal has been achieved, determining a reward for the entity; and
causing providing of the reward to the entity.

17. The apparatus of claim 16, wherein the reward is chosen from the group consisting of: an interest rate reduction for a home mortgage loan, an interest rate increase associated with a checking account, and a cash reward.

18. The apparatus of claim 16, wherein the financial data comprises bank account transaction data related to the entity.

19. The apparatus of claim 16, wherein the processor further performs: determining a second reward to the entity when the entity achieves the intermediate milepost of the financial goal.

20. A method comprising:
processing a financial goal associated with a customer;
determining, by a processor, a reward threshold based on the financial goal;
processing, over a predetermined period of time, transaction data associated with an account of the customer; and
causing a reward to be provided in response to determining that the transaction data indicates an adjustment in spending in excess of the reward threshold.
